(19) United States
(12) Patent Application Publication
(10) Pub. No.: US 2022/0143467 A1
(43) Pub. Date: May 12, 2022

(54) AUTOMATIC CONTROL OF A SINGLE OR MULTI-DIRECTIONAL TREADMILL

(71) Applicant: LANTERN HOLDINGS, LLC, Sterling, VA (US)

(72) Inventor: Chad Thomas GREEN, Sterling, VA (US)

(73) Assignee: LANTERN HOLDINGS, LLC, Sterling, VA (US)

(21) Appl. No.: 17/525,631

(22) Filed: Nov. 12, 2021

Related U.S. Application Data
(60) Provisional application No. 63/112,856, filed on Nov. 12, 2020.

(51) Int. Cl. A63B 24/00; G05B 13/02; A63B 22/02

(52) U.S. Cl. CPC A63B 24/0087; G05B 13/027; A63B 22/025; A63B 24/0062; A63B 2220/803; A63B 2220/05; A63B 2220/30; A63B 2220/13; A63B 2220/836; A63B 2024/0093

(57) ABSTRACT

A method and system using sensors and a deep neural network to control a treadmill based on user movement on the treadmill. Training data is collected to improve performance in a variety of typical as well as atypical treadmill activities to provide data with which to train a neural network for the task of controlling the treadmill. The method and system includes one or more sensors that obtain user movement and position data while the user is on the treadmill. A command unit (CU) stores the pre-trained neural network and receives the user movement and position data obtained by the one or more sensors. The CU determines the motion commands to provide to the treadmill based on the real-time data received from the sensor(s) and processed through the pre-trained neural network. A motion control processor (MCP) that controls power the treadmill motors receives the command data sent from the CU and controls the functions of the treadmill based on the motion command data which correlates to the inferred user movement.

### CROSS-REFERENCE TO RELATED APPLICATIONS

This application claims the benefit under 35 U.S.C. § 119(e) of the filing date of U.S. Patent Application No. 63/112,856, which was filed on Nov. 12, 2020 and which is incorporated here by reference.

### BACKGROUND

This specification relates to the automatic control of a single or multi-directional treadmill using a pre-trained neural network, optical sensors, and/or wireless wearable sensors.

Conventional treadmills allow for movement in a singular direction where a user moves at the speed that the treadmill platform is set to move, i.e., the user must keep pace with the machine. Thus, normal running or walking at a user's natural cadence, also called “free-running”, does not occur. Further, movement in multiple directions does not occur.

U.S. Pat. No. 10,016,656B2, titled “Automatically adjustable treadmill control system,” describes a ranging sensor that is used to measure the user's position relative to the treadmill center and adjust the treadmill speed automatically. Difficulties cited include alignment of the sensor relative to users of various heights as well as varying running styles.

Further, other conventional devices use pressure sensors in the treadmill base to detect user location relative to center. The speed of the treadmill is adjusted according to the distance from center. One weakness of this approach is that the user must leave the center before the treadmill will accelerate, inducing a lag in acceleration that is felt by the user. Also, this approach is only valid for standard walking/jogging motions and cannot determine when the user has fallen, causing unsafe conditions.

The above complications are overcome with the embodiments of the present invention with the use of both the sensor as well as the deep neural network which controls the treadmill based on the user's motion and generalizes the solution independent of user geometry or sensor placement. Also, the prior art is unable to anticipate when the user will stop or start and does not reference the ability to accommodate reversing motion or any atypical treadmill use such as athletic or rehabilitation applications.

### SUMMARY

Embodiments of the invention are described with examples of various sensor configurations. In embodiments of the invention, wearable sensors may include but are not limited to pressure sensors and inertial measurement units in custom sole inserts for athletic shoes, optically tracked markers, whether passive or active, magnetically tracked markers, or other devices which can be worn on the person to measure body motion. This innovation allows the treadmill user to start, stop, and set the speed of the treadmill simply by commencing said activities as one would on solid ground without having to set them manually by pressing buttons or other activation mechanisms. The user is then free to run, walk, or jog at whatever speed they feel comfortable in the same manner as they would in any environment.

The embodiments of the invention utilize a deep neural network in the method and process of training, controlling, and utilizing the treadmill. To train the neural network, data is first collected from a plurality of treadmill users performing typical activities on a standard treadmill while the sensors collect data. The sensor data is captured from a plurality of perspectives and orientations surrounding the user during a plurality of locomotive gestures (stopping, starting, running, walking, jogging, sprinting, etc.) while the speed of the standard treadmill is simultaneously being captured. This provides training data from which a deep neural network may be trained. A custom annotation method for generating the proper speed commands for each frame of training data is also described. The network learns not only to classify gestures, but also predict the speed of the treadmill that would keep the user centered on the treadmill. In the case of an imaging system, once the network is trained, only a single imaging sensor is required to be placed near the treadmill, having full view of the user. An embedded processor then runs inference on the live sensor data through the trained network and issues a speed command to the treadmill. Since the training data includes a plurality of users of varying heights, weights, cadences, sensor orientations, and gaits, the network is insensitive to these variables and is able to control the speed accurately and smoothly.

The embodiments of the invention comprise both the method of using sensors and a deep neural network to control a treadmill as well as the method to collect training data to improve performance in a variety of typical as well as atypical treadmill activities. For high-performance applications, an optional force sensor or sensors may be placed under the deck of the treadmill to measure foot strike force, providing additional information for the network to make better decisions in high-speed athletic maneuvers. In other embodiments, a haptic feedback system, such as pneumatic bladders in the custom sole inserts, may be included to provide additional sensory input in an immersive experience such as walking on a treadmill in virtual reality.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates multi camera data collection.

FIG. 2 illustrates a single camera running inference on a trained network.

FIG. 3 illustrates wearable sensors that track body movement

FIG. 4 illustrates an optical light screen.

FIG. 5 is flow chart of the collecting data, training and deploying the neural network.

FIG. 6 is a flow chart of the pre-trained neural network used in a treadmill.

Like reference numbers and designations in the various drawings indicate like elements.

### DETAILED DESCRIPTION

The embodiments of the present invention allow any user; any gender, body type, height, weight or size in general, to operate a treadmill without pressing any buttons. Since data is captured on a statistically representative sample of the general population, the neural network is able to generalize to body types and gaits that it has never seen before. Therefore, no further training or calibration is required by the user. The user may commence use of the system, simply by stepping on and moving at their desired pace/cadence. The system will adjust to the specific user's motions without any additional input from the user. The ability to “free-run”, just as one would on solid ground, provides many opportunities for enhanced indoor athletic training, physical therapy, and recreation.

Additionally, with multi-dimensional treadmills, the embodiments of the present invention allow users to move in any direction within the constraints of the treadmill. For example, a treadmill with control of two axes, will follow the user's motion in any direction of the horizontal X-Y plane. This includes walking, running, and other athletic activities.

In another embodiment using a multi-dimensional treadmill, the treadmill may be a spheroid in which the user walks inside the spheroid. Horizontal X-Y plane movement is simulated by maintaining the user in the bottom apex of the spheroid. Vertical Z-direction movement is achieved by allowing the user to move away from the apex, effectively climbing up the internal wall of the spheroid.

In another embodiment of a multi-dimensional treadmill, the treadmill may be a system of tiles which follow the positions of the feet by moving the tiles around the horizontal X-Y plane of the floor. The top surface of the tile is also able to raise and lower in the vertical Z direction, effectively creating stairs. In another embodiment of a multi-dimensional treadmill, the 2-dimensional treadmill is able to tilt in two axes to simulate walking up an incline.

One application of the automatically controlled treadmill would allow athletes to perform certain motions indoors that otherwise could only be performed outdoors or in a large space such as a gym. Some examples may include:
Starting block drills where the runner begins in a four-point stance
Offensive/defensive line training where an American football player may begin in a three-point stance
Stealing and base running where the baseball player may begin in a stance perpendicular to the treadmill, then rotate to sprint to the next base
Running “ladders” for basketball or other reverse-motion training. The “ladders” drill typically involves sprinting forward for a short period, then rapidly reversing motion to sprint in the opposite direction, repeated over several distance intervals
Interval training for improving sprinting speed
Warm-up routines such as high-stepping, lunges, and sashay movements side-to-side

For very dynamic movements, strike force is a more timely indicator of user acceleration and deceleration. The pressure sensors in the custom sole inserts provide additional and more timely clues to the neural network of what the athlete is intending to do.

All of the above movements are impossible on a standard treadmill or even newer pressure sensitive treadmills that set speed based on foot cadence or distance from center, but can be accomplished with the embodiments of the present invention. Any of the data capture and annotation methods described in this application may be used to generate training data on these complex motions.

Another application is physical therapy and patient rehabilitation. When a patient is re-learning how to walk due to traumatic injury, stroke, or physical disability, their motions are not only atypical to healthy individuals but also impulsive and erratic. Patients suffering from Parkinson's disease, for example, tend to shuffle-step, taking short, incremental steps at a higher cadence than usual. A physical therapist will encourage the Parkinson's patient to lengthen their stride, but patients are typically nervous about being unable to control their speed. A neural network trained to predict when the patient wants to start and stop would increase the confidence of the patient to move safely.

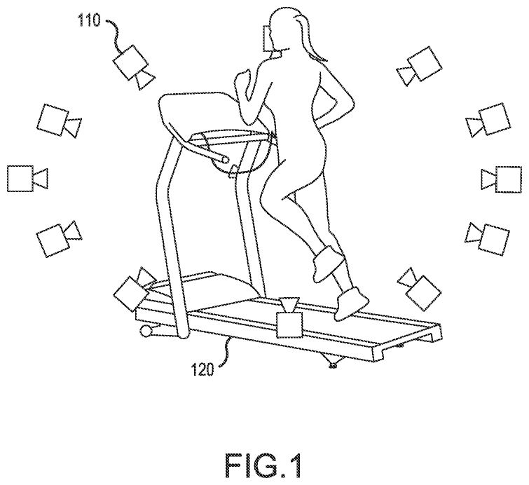

In order to achieve the ability for a user to run or walk in the manner described above on a treadmill, the treadmill must be trained by capturing data (pre-training process). FIG. 1 illustrates a data collection test rig to capture training data including video from multiple cameras 110 at a plurality of angles as well as various treadmill speeds. Multiple cameras 110 are set up surrounding the treadmill 120 and user. These cameras 110 are placed in prospective locations where a single camera might be mounted in a final system. The speed of the treadmill is captured during all data collection events and synchronized to the video.

The purpose of the training data is to provide the neural network with a very diverse set of data that is representative of not only diverse human gaits, but human locomotive gestures as well. The network requires both the sensor input (each timestamp of sensor input) as well as annotation files with the correct velocity command which will become the network output. Having accurate annotations is crucial to a high-performing network as the difference between predicted network output and the values found in the annotation files determines the error function that is calculated and back-propagated through the network during training. Any error in the annotation file will adversely affect the performance of the network.

In embodiments of the present invention, the sensor input may be comprised of cameras 110 of one or more types including monocular video, stereoscopic video, depth imagery such as from a time-of-flight camera, or another sensor device capable of determining the 3D pose of the user, pressure and inertial sensors in custom sole inserts 130, inertial measurement units, magnetic position sensors, inertial sensors with optical correction from external lighthouses, or passive optically-tracked markers which are monitored from external cameras 110, or other position sensors. The wearable sensors 140 are worn in various positions on the body with the most important being the feet and hip positions. For each timestamp in the sensor data stream (a single time stamp comprising the most timely data from all sensors at the given timestamp), the appropriate deck speed is sampled, recorded, and synchronized to the sensor data using a high-resolution rotary encoder on the treadmill surface.

An important feature of embodiments of the present invention is the method by which the appropriate deck speed is set. For steady-state velocity, the speed is easily determined by the encoder on the treadmill, but during rapid acceleration or deceleration by a user, the speed required to match the user's intended speed must either be calculated through post-processing of the training data, or set by a human “trainer” during data capture. Several scenarios where a “trainer” is required are described below.

One of the most difficult scenarios to model in human locomotion is stopping and starting. There is no deterministic motion that always occurs when a human begins to walk. Each individual's gait is almost as unique as their fingerprint. However, there are many clues that tend to indicate intent, such as shifting weight, lifting a foot, swinging arms, and other gestures that are common to most treadmill users. To capture the human's intent, one of several methods may be utilized to provide good results:

Post-processing: The user is fully-instrumented with the described sensors while a motion capture system is used to capture the user's ground-truth motion on solid ground. The ground-truth is compared to the captured sensor data, and in post-processing, the motion of the user, relative to the floor, is subtracted from the dataset such that the user now appears to be walking in place. This only works for short distances as the user's motion is restricted by the size of the motion capture studio. This works well for stopping and starting, but steady state motion requires the use of a treadmill in the motion capture studio as well.

Human Trainer: The user is fully-instrumented with the described sensors while a second person, the “trainer”, is tasked to control the speed of the treadmill manually during the user's stop and start actions on the treadmill. The purpose of the “trainer” is to intuit the user's intent and set the speed appropriately through the use of a remote controller, such as a joystick or gaming controller. The trainer and user must communicate clearly with each other to ensure the treadmill speed feels natural to the user as this is what the network will assume is correct and train to the “answer” set by the human trainer.

Direct User Input: The user is fully-instrumented with the described sensors. The user is given a remote control device that is hand-held, such as a thumbwheel controller, to set the speed of the deck manually. Practice is required by the user to get a feel for the sensitivity of the controller, but once sufficient proficiency is achieved, this is the most natural-feeling method as the user is in full control.

Basic control algorithm with feedback loop: The speed of the treadmill is set by control algorithms based on feedback from wearable position sensors. The user is fully-instrumented with the described sensors and the tracker is worn on the user's belt, providing 6-dimensional pose information. Based on this data, the speed is controlled to keep the user centered on the treadmill belt, regardless of the user's walking or running speed. For steady-state motion, this method works very well and has been demonstrated on multi-dimensional treadmills. However, stopping and starting still remain the most difficult motions to control without inducing unnatural acceleration to the user. Therefore, the user carries the remote control described above in the Direct User Input section to indicate when they intend to stop or start, and the basic control algorithm executes a preprogrammed stop or start acceleration profile, making the action feel more natural.

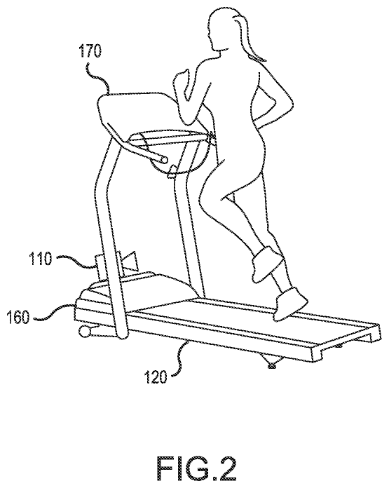

Once trained, the neural network can be deployed and used on a treadmill in a final configuration. FIG. 2 illustrates a final sensor configuration where only one imaging sensor 110 is required for real-time inference (not training) on the pre-trained neural network. The pre-trained neural network is optimized and deployed to an embedded processor, herein referred to as the Command Unit (CU) 160 located on or near the treadmill. The CU 160 interfaces with both the sensor (or a plurality of sensors) as well as the electronics that control the treadmill motor speed, herein referred to as the Motion Control Processor (MCP) 170. It is not necessary that the CU 160 controls the motors directly. The MCP 170 is dedicated to the task of controlling power to the motors as well as receiving feedback from motion sensors, typically rotary encoders or other motion sensors. The MCP 170 samples the encoders at a very high update rate and rapidly applies corrections to motor power in order to accurately control the speed and position of the mechanical system, even with external mechanical disturbances to the system. Motion control processors run algorithms that are tuned to the mass, friction, stiction, and other mechanical variables of the system. The embodiments of the present invention do not replace the MCP 170. Instead, the embodiments of the present invention provide motion commands to the MCP 170 such as, “move a given distance in a given direction.” The motion controller is then responsible for accurately creating the motion as commanded using standard control algorithms. Therefore, the pre-trained neural network does not have to be customized to each treadmill. For any given MCP 170, the execution code in the CU 160, including the pre-trained neural network, only has to be modified to give the motion commands in the correct format as required by the specific MCP 170.

Additionally, due to the diversity of training data collected, the plurality of sensors described in the training process are not required for real-time inference. The single sensor 110 performs well by itself, irrespective of alignment with the user on the treadmill 120. The sensor may be placed in any position relative to the user that allows for the full body motion to be captured in the sensors field-of-view, with the requirement that the sensor must be identical or at least representative of the sensors used in training. For example, if only cameras were used in training, then camera data of similar frame-rate, resolution, and field of view, must be used for inference. Similarly, if only wearable sensors were used in training, then wearable sensors must be used during real-time inference with a data stream representative of the sensor used in training.

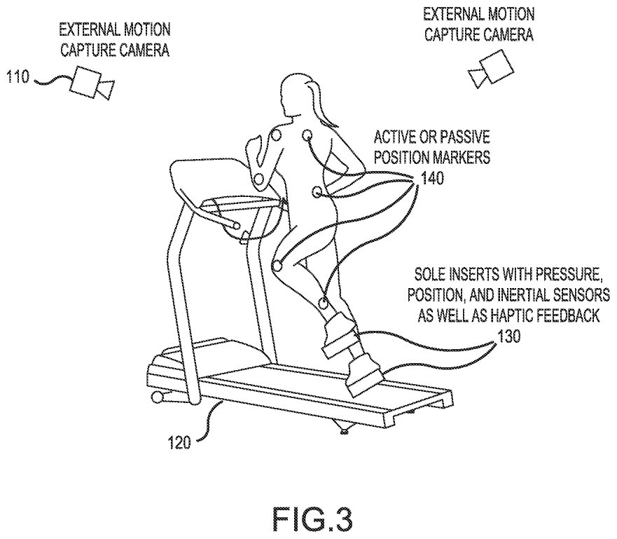

FIG. 3 illustrates an embodiment in which a data collection test rig to capture pressure, inertial, position, and/or 6 DOF (degrees of freedom) pose from multiple positions on the user is used. The speed of the treadmill 120 is captured during all data collection events and synchronized to the sensor data. Data is captured in a plurality of user motions, gestures, and athletic sequences. External cameras 110 are used to capture motion while markers 140, which may be active or passive, are positioned on the body at key movement areas to collect body movement data. Sole inserts 130 may be placed in the users shoes to that include pressure, position and inertial sensors and collect data from these sensors.

The sole inserts 130 may also include haptic feedback actuators. The haptic feedback actuators in the custom sole inserts 130 may indicate different floor or terrain textures. For example, carpet may be simulated by reducing pressure in the pneumatic bladders in the sole, creating a compliant surface. Hardwood may be simulated by inflating the bladders to create a rigid walking surface. Irregular surfaces, such as gravel, may be emulated by many individually controllable bladders.

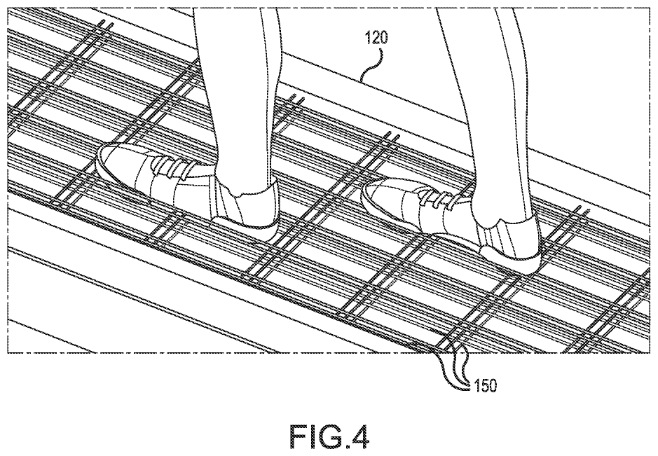

Accurate foot position sensing and tracking is needed for the network to be able to create a more accurate estimate of the user's intended velocity. Skeletal tracking is enabled by the methods previously discussed using computer vision, but the precise location and speed of both feet is more difficult to infer. In embodiments of the present invention an optional foot tracking sensor may be used for this purpose. The sensor may be comprised of multiple optical break screens as shown in FIG. 4. In FIG. 4 a foot tracking light screen implemented on a treadmill 120 is illustrated. Multiple optical break screens are used to track foot position in three dimensions. Two or more layers of 2-axis break screens 150 are shown. Within a layer, the two break screens 150 are positioned orthogonally, creating an X-Y cartesian plane where occluded pixels indicate the X-Y position of an object. The additional layer(s) work(s) identically to the first, and provide Z position. The time between an object penetrating adjacent vertical layers provides a measurement of velocity in the Z axis, whereas a time between an object occluding adjacent pixels provides a measurement of velocity in the X-Y plane.

Alternatively, each sensor may be a single-pixel ranging sensor, such as lidar, placed in an array on a printed circuit board. For the purposes of the embodiments of the present invention, the sensor method must deterministically locate the X-Y position of both feet at all times. The Z position, or distance of the foot above the plane of the treadmill is also helpful in determining when the foot is making contact with the treadmill. In one embodiment of the foot tracking optical sensor, an IR break screen similar to those used in retrofitting large visual displays with touch sensing capability, may be used. Two of these break screens stacked on top of each other make a 3D position sensor which lays just above the surface of the treadmill for foot tracking. In another embodiment, a lidar camera may be used to accurately measure foot position in 3D.

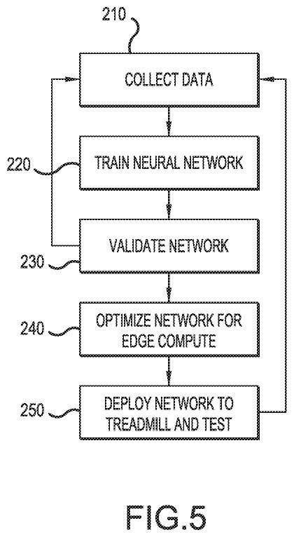

FIG. 5 is a flowchart which outlines the process/method of embodiments of the present invention. First, data is collected 210 from human users using one or more of the methods described above. The captured data is then used for training and validating the neural network 220. This process is iterative until satisfactory performance is achieved in the validation step 230. Finally, the network is optimized for edge computing and deployed to the treadmill for real-time control of treadmill speed 240. The full, end-to-end process is repeated until satisfactory performance is achieved on the treadmill 250.

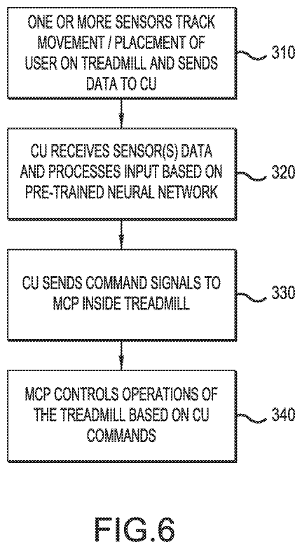

Once the neural network is trained, it can be deployed to the CU 160 in the treadmill. FIG. 6. is a flow chart with the pre-trained neural network deployed in a treadmill. Once deployed in the treadmill, the number of sensors used can be limited to only one sensor as discussed above, but may include more. The one or more sensors track the movement/position of the user 310 on the treadmill track and send this data to the CU 160. The CU 160 receives the sensor(s) data and processes this data 320 inferring the users movement and position. The CU 160 determines the commands to send to the MCP 170 based on the real-time data received from the sensor(s) and processed through the pre-trained neural network. The CU 160 then sends the commands to the MCP 170 (330). The MCP 170 controls the operations of the treadmill based on the commands provided by the CU 160 (340). This process is repeated while the user is using the treadmill. Thus, the treadmill reacts to the user's movements, cadence, speed, etc allowing for a smooth and more natural response to the user's motion.

In embodiments where a neural network is used, the network must be pre-trained. The process of capturing data, training, and validating the neural network is repeated many times until the acceptable performance is obtained. Following validation, the network is optimized to fit and perform within the constraints of the processor 270. The optimized network is deployed to that device where real-time performance may be measured.

The purpose of the training data is to provide the neural network a very diverse set of data that is representative of a plurality of actual use scenarios. The network requires both the sensor input (each timestamp of sensor input) as well as annotation files with the correct annotation which will become the network output. Having accurate annotations is crucial to a high-performing network as the difference between predicted network output and the values found in the annotation files determines the error function that is calculated and back-propagated through the network during training. Any error in the annotation file will adversely affect the performance of the network.

In embodiments of the present invention, the sensor input to the network may be comprised of time-series data, such images from a video stream, depth information from depth imagers, inertial data from sensors worn by the treadmill user, as well as wireless magnetic sensors that provide real-time 6 DOF pose information. Additionally, the 6 DOF pose of the user may be captured by external instrumentation such as a motion capture system and synchronized to the other sensor data to simplify and automate data annotation as described previously.

The data may be captured using an instrumented motion capture system. Users as well as their head-mounted or body-worn or fixed location imagers are instrumented with markers that the motion capture system can detect accurately. Their 6 DOF pose within the motion capture system is recorded at all times. Users are instructed to perform typical locomotive actions in a plurality of representative scenarios, such as walking, running, jogging, etc. The treadmill surface is also instrumented by mechanical encoders or by affixing optical fiducials that the real-time imagers will detect. For each frame of sensor input, all annotations must be correctly recorded

Once sufficient data has been captured and annotated, network training begins. The data is consolidated into a training set and test set. The training files are repeatedly fed to the neural network during training routines, while the test set is used exclusively for evaluating the performance of each training cycle. In this manner, the network is always evaluated using test data that it has never seen before.

During the training cycle, hyper-parameters are optimized such as learning rate, batch size, momentum, and weight decay. Additionally, several optimization methods may be explored to improve the accuracy of the network such as Stochastic Gradient Descent or Adam and/or other variants as best practices in training methods evolve.

Once satisfactory network performance has been achieved, a final evaluation step on real-world data is necessary to determine how well the network generalizes to new data, including new users and new user actions. During this validation process, data is again collected and annotated for future training cycles to remove outliers in performance. This training sequence is iteratively repeated to continually improve performance and add new test conditions and scenarios.

After training is complete, the network is frozen and optimized for efficient performance on an embedded device. This process may include quantizing the network, removing floating point operations and extraneous test and debug nodes. This improves performance on a resource-constrained device, such as a microcontroller, FPGA, or neural network accelerator. The frozen neural network is included when compiling the run-time executable, machine instructions, etc. Real-time data, as captured by the device, is then passed through the network during live operation of the treadmill, and real-time motion control commands are issued to the Motion Control Processor (MCP).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more memory devices for storing data. However, a computer need not have such devices.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

What is claimed is:

1. A system for controlling a treadmill by a user's movement, comprising:
one or more sensors that obtain user movement and position data on the treadmill;
a command unit (CU) having stored therein a pre-trained neural network, the CU receiving the user movement and position data obtained by the one or more sensors and determining command data based on the pre-trained neural network and received data;
a motion control processor (MCP) that receives the command data sent from the CU and controls the functions of the treadmill based on the command data.

2. The system of claim 1, wherein the one or more sensors is limited to one imaging sensor.

3. The system of claim 1, wherein the command data infers the movement and position of the user in real time.

4. The system of claim 3, wherein the treadmill reacts to the user's movements, cadence, speed, and position based on the inferred command data.

5. The system of claim 1, wherein the pre-trained neural network is trained by collecting data using one or more cameras capable of determining a 3D pose of a user, or wearable sensors monitored by the one or more external cameras.

6. The system of claim 1, wherein the pre-trained neural network is trained by collecting data using a foot tracking light screen.

7. A method for controlling a treadmill by a user's movement, comprising:
obtaining, using one or more sensors, user movement and position data on the treadmill;
receiving by a command unit (CU) having stored therein a pre-trained neural network, the user movement and position data obtained by the one or more sensors;
determining command data by the CU based on the pre-trained neural network and received data;
receiving, by a motion control processor (MCP) the command data sent from the CU; and
controlling, by the MCP, the functions of the treadmill based on the command data.

8. The method of claim 7, wherein the one or more sensors is limited to one imaging sensor.

9. The method of claim 7, wherein the command data infers the movement and position of the user in real time.

10. The system of claim 9, wherein the treadmill reacts to the user's movements, cadence, speed, and position based on the inferred command data.

11. The method of claim 7, wherein the pre-trained neural network is trained by collecting data using one or more cameras capable of determining a 3D pose of a user, or wearable sensors monitored by the one or more external cameras.

12. The system of claim 7, wherein the pre-trained neural network is trained by collecting data using a foot tracking light screen.
